(19) United States
(12) Patent Application Publication
(10) Pub. No.: US 2007/0045185 A1
(43) Pub. Date: Mar. 1, 2007

(54) MODULAR FLOW DIRECTING COUPLING SYSTEM

(75) Inventors: Russell E. Prescott, Kingston, NH (US); Perrin T. Prescott, Exeter, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: R.E. PRESCOTT CO., INC., Exeter, NH (US)

(21) Appl. No.: 11/551,936

(22) Filed: Oct. 23, 2006

Related U.S. Application Data
(63) Continuation-in-part of application No. 11/211,415, filed on Aug. 25, 2005.

(51) Int. Cl. C02F 1/26

(52) U.S. Cl. 210/634

(57) ABSTRACT

A modular flow directing coupling system may be used to direct a flow of water through water treatment devices in a water treatment system. The modular flow directing coupling system may include a plurality of manifold blocks configured to be coupled together and to the water treatment devices in various configurations. The modular flow directing coupling system may also include one or more loop-around blocks, tank adapters, valves and other devices.

### CROSS-REFERENCE TO RELATED APPLICATION

The present application is a continuation-in-part of U.S. patent application Ser. No. 11/211,415 filed on Aug. 25, 2005, which is fully incorporated herein by reference.

### TECHNICAL FIELD

The present invention relates to water supply systems and more particularly, to a modular flow directing coupling system for use in coupling water treatment devices to a water supply system.

### BACKGROUND INFORMATION

Water treatment systems are commonly used in water supply systems. In a residential water supply system, for example, water softeners, acid neutralizers, iron/manganese removal systems, arsenic removal systems, and aeration systems may be used to filter and/or treat the water being supplied from a water source (e.g., from a well or city water supply). Such systems may require coupling multiple filters, tanks and other devices into the system such that the water is filtered and/or treated before being supplied into the home. To connect such systems, pipes, valves and other equipment often must be coupled together to direct water into the tanks and filters. Plumbing the pipes, valves and other equipment into an existing water supply system may be tedious and time consuming.

Accordingly, there is a need for a modular flow directing coupling system that facilitates the incorporation of water treatment devices into an existing water supply system.

### BRIEF DESCRIPTION OF THE DRAWINGS

These and other features and advantages will be better understood by reading the following detailed description, taken together with the drawings wherein:

FIGS. 1-5 are schematic views of water treatment systems configured using a modular flow directing coupling system, consistent with embodiments of the present invention.

FIG. 6 is a plan view of one embodiment of a manifold block for use in a modular flow directing coupling system.

FIG. 7 is a plan view of another embodiment of a manifold block for use in a modular flow directing coupling system.

FIG. 8 is a bottom view of another embodiment of a modular flow directing coupling system configured to be coupled to a tank.

FIG. 9 is a side view of the modular flow directing coupling system shown in FIG. 8.

### DETAILED DESCRIPTION

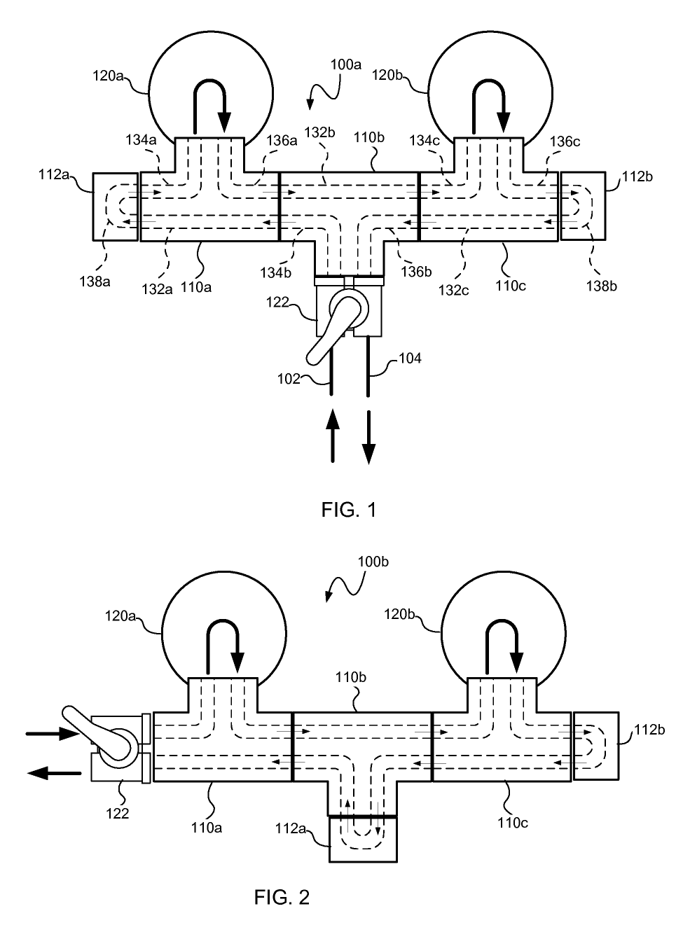

Referring to FIGS. 1-5, modular flow directing coupling systems, consistent with embodiments of the present invention, may be arranged in various configurations to form modular water treatment systems 100a-100e. The modular water treatment systems 100a-100e direct water from a supply line 102 through water treatment devices 120a-120d to a delivery line 104. The supply line 102 may supply water from a water source such as a well or city water supply. The delivery line 104 may provide water to a building, such as a residential home. The water treatment systems 100a-100e may be coupled, for example, to a residential water supply system at the point of entry. The water treatment system 100a-100e may also be configured for use in a commercial water supply system.

Modular flow directing coupling systems include multiple configurable components that facilitate installation of the water treatment systems 100a-100e. One embodiment of a modular flow directing coupling system may include a plurality of manifold blocks 110a-110c coupled together to form a modular water treatment system 100a, as shown in FIG. 1. Each of the manifold blocks 110a-110c in the flow directing coupling system 100a may be substantially identical in that the dimensions are substantially the same within manufacturing tolerances. Each of the manifold blocks 110a-110c may include passageways 132a-132c, 134a-134c, 136a-136c configured to direct water through the manifold blocks to other manifold blocks or components coupled thereto.

The modular flow directing coupling system may also include loop-around blocks 112a, 112b that may be coupled to the manifold blocks (e.g., manifold blocks 110a, 110b) to loop water around and back through the manifold blocks. The loop-around blocks 112a, 112b may include a single passageway 138a, 138b that loops around to direct water from an outlet of a manifold block to an inlet on the same side of the manifold block. The loop-around blocks 112a, 112b may be dimensioned to match the manifold blocks 110a, 110b such that the passageways 138a, 138b align with passageways 132a, 134a, 132c, 136c.

The modular flow directing coupling system may further include a valve 122 coupled between a manifold block 110b and the supply line 102 and delivery line 104. In an exemplary embodiment, the valve 122 may be a by-pass valve such as the type known to those skilled in the art for use in residential water systems. The modular flow directing coupling system may further include components (not shown) for coupling the manifold blocks 110a-110c to the water treatment devices 120a-120c, such as tank adapters, as will be described in greater detail below. The modular flow directing coupling system may further include coupling devices (not shown) for coupling the manifold blocks 110a- 110c to each other and to other components, as will be described in greater detail below.

A modular flow directing coupling system may be used in any system where water is directed through a plurality of water treatment devices 120a-120c. The modular flow directing coupling system may eliminate additional plumbing connections for the additional water treatment devices. Examples of water treatment devices include, but are not limited to, water softeners, acid neutralizers, iron/manganese removal systems, arsenic removal systems, other contaminant removal systems, and aeration systems. Water treatment devices may also include water heaters or other devices that alter the temperature or other conditions of the water. Water treatment devices may further include tanks or other devices that store or allow water to pass through as part of a treatment process. The water treatment devices coupled using the modular flow directing coupling system may include redundant water treatment devices (e.g., redundant arsenic removal systems) or may include different water treatment devices (e.g., an acid neutralizer and a water softener) One embodiment may include first and second filter tanks including a filter medium that removes or reduces the level of contaminants in the water as the water flows through the medium, such as the type disclosed in greater detail in U.S. patent application Ser. No. 11/211,415 filed on Aug. 25, 2005, incorporated herein by reference. In an arsenic removal system, for example, the filter medium may include a hybrid ion exchange resin such as the type available under the name ArsenXnp™ from SolmeteX Inc. and Purolite Inc.

The manifold blocks 110a-110c may be arranged according to various configurations, for example, depending upon the location of the supply line 102, the location of the delivery line 104, the desired location of the water treatment devices 120a-120c, and the existing plumbing. In the water treatment system 100a shown in FIG. 1, for example, a by-pass valve 122 is coupled between a centrally located manifold block 110b and the supply line 102 and delivery line 104. The water treatment devices 120a, 120b are coupled to manifold blocks 110a, 110c on a side opposite the valve 122, and the loop-around devices 112a, 112b are coupled to ends of the manifold blocks 110a, 110c. The water passes from the supply line 102 through the valve 122, through the manifold blocks 110a-110c, through the loop-around devices 112a, 112b, and through the treatment devices 120a, 120b, as indicated by the arrows. The water treatment system 100b shown in FIG. 2 has a similar configuration with the valve 122 coupled to an end of the manifold block 110a and a loop-around block 112a coupled to the centrally located manifold block 110b.

The water treatment systems 100c, 100d shown in FIGS. 3 and 4 are configured from two manifold blocks 110a, 110b and a loop-around block 112. In the water treatment system 100c shown in FIG. 3, the water treatment devices 120a, 120b are coupled to the manifold blocks 110a, 110b on a side and an end, respectively, with the valve 122 coupled to the manifold block 110b on one side. In the water treatment system 100d shown in FIG. 4, the water treatment devices 120a, 120b are coupled to the manifold blocks 110a, 110b on opposite sides with the valve 122 at one end of the manifold block 110b.

The water treatment system 100e shown in FIG. 5 is configured from three manifold blocks 110a-110c coupled to four water treatment devices 120a-120d. In this configuration, a by-pass valve 122 is coupled to a centrally-located manifold block 110b but may be coupled to either of the other manifold blocks 110a, 110c. This exemplary configuration does not include any loop-around blocks.

The water treatment systems 100a-100e illustrated are only examples of different configurations formed using modular water directing coupling systems. Those of ordinary skill in the art will recognize that the manifold blocks, and optionally the loop-around blocks and valves, may be coupled in any number of configurations.

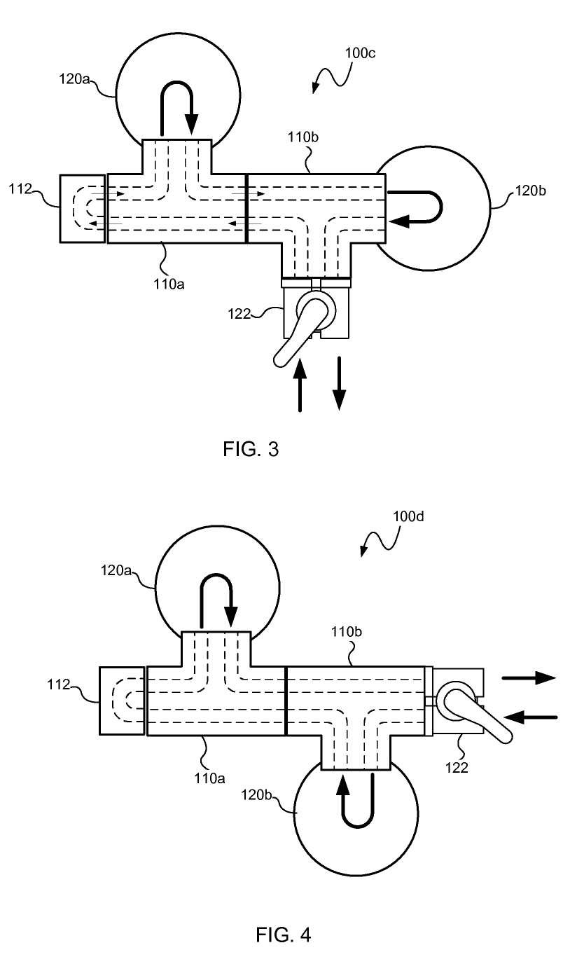

One embodiment of a manifold block 110 is shown in greater detail in FIG. 6. According to this embodiment, the manifold block 110 has a generally T-shaped body portion defining passageways 132, 134, 136. The manifold block 110 may include inlet/outlet ends 140, 150, 160 having inlet/outlet sides 142, 152, 162. In this embodiment, the passageway 132 extends between two of the inlet/outlet ends 140, 160, the passageway 134 extends between two of the inlet/outlet ends 140, 150, and the passageway 136 extends between two of the inlet/outlet ends 150, 160. The inlet/outlet sides 142, 152, 162 each provide an inlet or an outlet to the passageways extending to the corresponding ends 140, 150, 160. In the illustrated embodiment, for example, the inlet/outlet side 142 defines an opening 144 to passageway 132 and an opening 146 to passageway 134, inlet/outlet side 152 defines an opening 154 to passageway 134 and an opening 156 to passageway 136, and inlet/outlet side 162 defines an opening 164 to passageway 132 and an opening 166 to passageway 136. The openings 144, 146, 154, 156, 164, 166 may act as inlets or outlets with respect to the passageways 132, 134, 136 depending upon the configuration.

The manifold block 110 may be shaped and configured such that each of the inlet/outlet sides 142, 152, 162 are configured to be coupled to inlet/outlet sides of other manifold blocks. The inlet/outlet sides 142, 152, 162 of a manifold block may also be coupled to other components, such as water treatment devices, supply and delivery lines, and/or valves. In one embodiment, the inlet/outlet sides 142, 152, 162 of the manifold block 110 and the top and bottom surfaces of the manifold block 110 may be substantially flat. In one example used with 10 inch diameter tanks, a manifold block 110 may have a length of about 6 inches, a width of about 5 inches, and a thickness of about 1½ inches. The passageways 132, 134, 136 may have a diameter of about ½ in. or greater. The manifold block 110 may be made of polyvinyl chloride (PVC) or other suitable material.

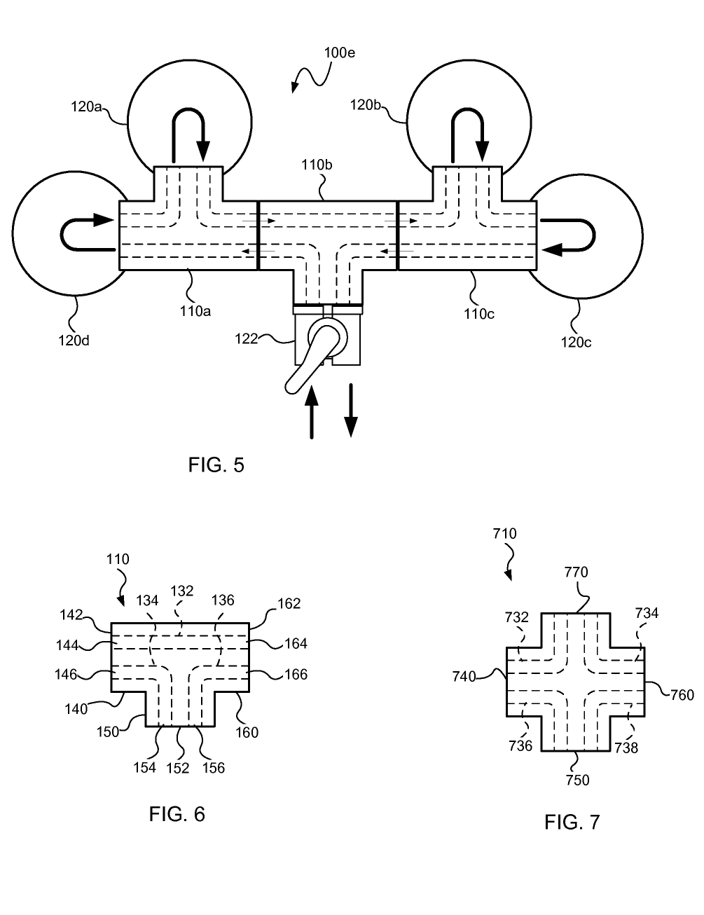

Although FIGS. 1-6 show manifold blocks having a T shape, other shapes and configurations are possible. As shown in FIG. 7, for example, a manifold block 710 may include four inlet/outlet ends 740, 750, 760, 770 and four passageways 732, 734, 736, 738.

Modular flow directing coupling systems may also include flow monitoring and control devices (e.g., incorporated into the manifold blocks) to monitor the flow of water through various points within the systems. Flow monitoring devices may include pressure gauges (not shown) coupled to the passageways in the manifold blocks to monitor water pressure in the passageways, a flow meter or sensor (not shown) to sense flow, and/or a flow monitor (not shown) to monitor flow characteristics such as flow volume and rate. Manifold blocks may further include taps (not shown) fluidly coupled to one or more of the passageways to allow water to be tapped or removed as the water flows into and out of the tanks. Manifold blocks may further include a flow control device (not shown) located in one or more passageways to control flow of water through the passageway. Examples of such flow monitoring and control devices are described in greater detail in U.S. patent application Ser. No. 11/211,415 filed on Aug. 25, 2005, incorporated herein by reference

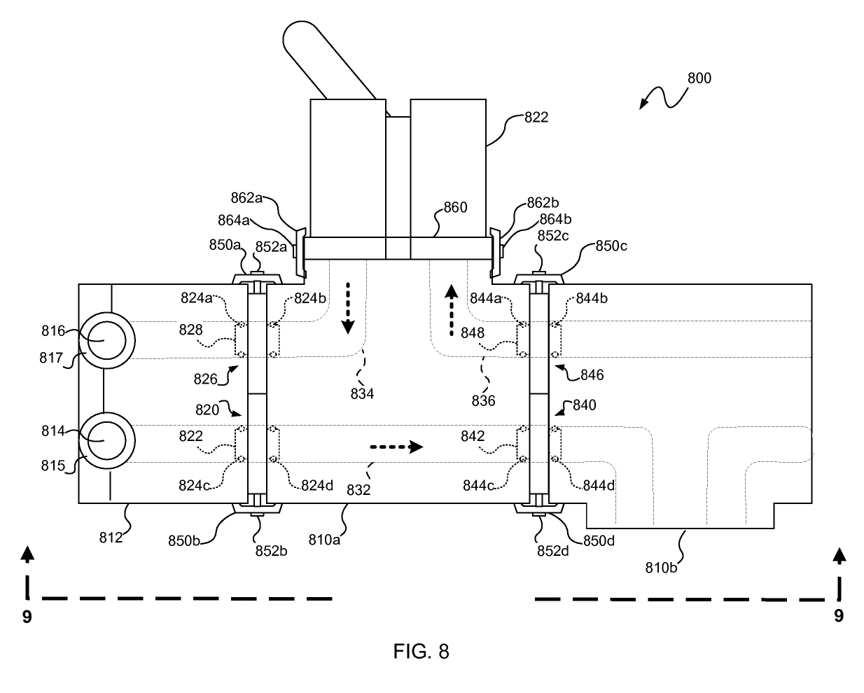

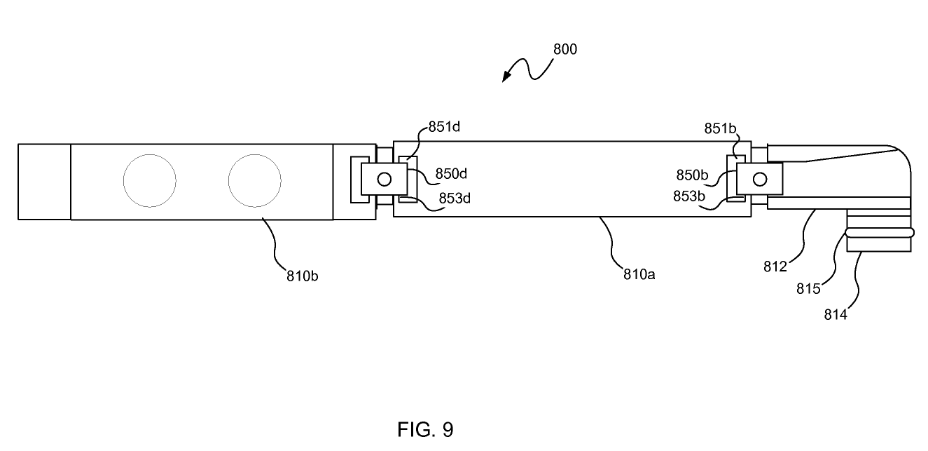

Referring to FIGS. 8 and 9, a modular flow directing coupling system 800 may also include coupling devices used to couple manifold blocks 810a, 810b to each other and to other components. The modular flow directing coupling system 800 may include one or more tank adapters 812 coupled to a manifold block 810a. A tank adapter 812 may include tank engaging portions 814, 816 that are configured to extend into openings in a tank head (not shown) to fluidly connect the flow directing coupling system 800 to the tank. O-rings 815, 817 may be positioned around each of the tank engaging portions 814, 816 to seal against the respective openings in the tank heads. The tank adapter 812 may be made of a carbon fiber composite or another suitable material.

Couplers 820, 826 may be positioned between the manifold block 810a and the tank adapter 812 to fluidly couple the tank adapter 812 to the manifold block 810a. Couplers 840, 846 may also be positioned between the manifold blocks 810a, 810b to fluidly couple the manifold blocks 810a, 810b to each other. The couplers 820, 826, 840, 846 may include portions 822, 828, 842, 848 that extend into the respective passageways of a manifold block (e.g., passageways 832, 834, 846 of manifold block 810a). One example of the couplers 820, 826, 840, 846 include the adapter couplings available from Fleck Controls, Inc. under Fleck P/N 19228. O-rings 824a-824d, 844a-844d may be positioned around each of the respective coupler portions 822, 828, 842, 848 to seal against the inner surfaces of the passageways (e.g., passageways 832, 834, 846 of manifold block 810a). One example of the O-rings include adapter coupler O-rings available from Fleck Controls, Inc. under Fleck P/N 13305.

One or more fastening clips 850a-850d with screws 852a-852d or other type of fastener may be used to mechanically secure the manifold block 810a to the tank adapter 812 and to the manifold block 810b with the couplers 820, 826, 840, 846 sandwiched in between. One example of the clips and screws include the adapter coupling clips and screws available from Fleck Controls, Inc. under Fleck P/N 13255 and P/N 13314. The manifold blocks 810a, 810b and the tank adapter 812 may include recessed portions (e.g., recessed portions 851b, 851d in manifold block 810a) that receive the clips (e.g., clips 850b, 850d) and engaging portions (e.g., engaging portions 853b, 853d) that are engaged by the clips (see FIG. 9).

A coupler 860 may also be used to couple a by-pass valve 822 to the manifold block 810a. One or more fastening clips 862a, 862b with screws 864a, 864b or other fasteners may be used to mechanically secure the by-pass valve 822 to the manifold block 810a with the coupler 860 sandwiched in between.

In summary, a modular flow directing coupling system may be used to couple water treatment devices to a water system according to different configurations such that water is directed through the water treatment devices.

Consistent with one embodiment, a modular flow directing coupling system includes a plurality of manifold blocks configured to be coupled together to direct a flow of water therethrough. Each of the manifold blocks includes a body portion defining at least three passageways through the body portion and at least three inlet/outlet sides on the body portion. Each of the inlet/outlet sides defines openings to two of the passageways. The openings are configured to act as an inlet to or outlet from the respective passageways.

Consistent with another embodiment, a manifold block includes a T-shaped body portion including first, second and third inlet/outlet ends. The body portion defines first, second and third passageways. The first passageway extends between the first and third inlet/outlet ends, the second passageway extends between the first and second inlet/outlet ends, and the third passageway extends between the second and third inlet/outlet ends. The first, second and third inlet/outlet ends have respective first, second and third inlet/outlet sides, each defining openings to two of the passageways. The openings are configured to act as an inlet to or outlet from the respective passageways.

Consistent with a further embodiment, a water treatment system includes at least first and second water treatment devices and a flow directing coupling system comprising a plurality of manifold blocks coupled together and coupled to the water treatment devices to direct water through the water treatment devices. Each of the manifold blocks includes a body portion defining at least three passageways through the body portion and at least three inlet/outlet sides on the body portion. Each of the inlet/outlet sides defines openings to two of the passageways. The openings are configured to act as an inlet to or outlet from the respective passageways.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A modular flow directing coupling system comprising:
a plurality of manifold blocks configured to be coupled together to direct a flow of water therethrough, each of the manifold blocks comprising:
a body portion defining at least three passageways through the body portion; and
at least three inlet/outlet sides on the body portion, each of the inlet/outlet sides defining openings to two of the passageways, wherein the openings are configured to act as an inlet to or outlet from the respective passageways.

2. The modular flow directing coupling system of claim 1 further comprising at least one loop-around block configured to be coupled to one of the inlet/outlet sides of one of the manifold blocks.

3. The modular flow directing coupling system of claim 1 wherein the plurality of manifold blocks include first, second and third manifold blocks.

4. The modular flow directing coupling system of claim 1 further comprising coupling devices configured to couple the manifold blocks together.

5. The modular flow directing coupling system of claim 1 wherein a plurality of the manifold blocks are substantially identical.

6. The modular flow directing coupling system of claim 1 wherein each of the manifold blocks is T-shaped.

7. The modular flow directing coupling system of claim 6 wherein each of the manifold blocks includes first, second and third inlet/outlet ends and defines first, second and third passageways, wherein the first passageway extends between the first and third inlet/outlet ends, wherein the second passageway extends between the first and second inlet/outlet ends, and wherein the third passageway extends between the second and third inlet/outlet ends.

8. The modular flow directing coupling system of claim 1 further comprising a by-pass valve configured to be coupled to one of the inlet/outlet sides of one of the manifold blocks.

9. The modular flow directing coupling system of claim 1 further comprising at least one tank adapter configured to be coupled to one of the inlet/outlet sides of one of the manifold blocks.

10. A manifold block comprising:
a T-shaped body portion including first, second and third inlet/outlet ends, the body portion defining first, second and third passageways, wherein the first passageway extends between the first and third inlet/outlet ends, wherein the second passageway extends between the first and second inlet/outlet ends, and wherein the third passageway extends between the second and third inlet/outlet ends, the first, second and third inlet/outlet ends having respective first, second and third inlet/outlet sides, each of the first, second and third inlet/outlet sides defining openings to two of the passageways, wherein the openings are configured to act as an inlet to or outlet from the respective passageways.

11. The manifold block of claim 10 wherein a diameter of the passageways is at least about ½ in.

12. The manifold block of claim 10 wherein the manifold block is made of PVC.

13. The manifold block of claim 10 wherein the inlet/outlet sides are substantially flat.

14. The manifold block of claim 10 wherein top and bottom surfaces of the T-shaped body portion are substantially flat.

15. A water treatment system comprising:
at least first and second water treatment devices; and
a flow directing coupling system comprising a plurality of manifold blocks coupled together and coupled to the water treatment devices to direct water through the water treatment devices, each of the manifold blocks comprising:
a body portion defining at least three passageways through the body portion; and
at least three inlet/outlet sides on the body portion, each of the inlet/outlet sides defining openings to two of the passageways, wherein the openings are configured to act as an inlet to or outlet from the respective passageways.

16. The water treatment system of claim 15 further comprising at least one loop-around block coupled to one of the inlet/outlet sides of one of the manifold blocks.

17. The water treatment system of claim 15 wherein at least one of said water treatment devices includes a tank, and further comprising at least one tank adapter coupled to one of the inlet/outlet sides of one of the manifold blocks.

18. The water treatment system of claim 15 wherein each of the manifold blocks includes first, second and third inlet/outlet ends and defines first, second and third passageways, wherein the first passageway extends between the first and third inlet/outlet ends, wherein the second passageway extends between the first and second inlet/outlet ends, and wherein the third passageway extends between the second and third inlet/outlet ends.

19. The water treatment system of claim 15 further comprising a by-pass valve coupled to one of the manifold blocks, the by-pass valve being operable to by-pass flow through the flow directing coupling system and the water treatment devices.
